(19) United States
(12) Patent Application Publication
(10) Pub. No.: US 2026/0297252 A1
(43) Pub. Date: Oct. 1, 2026

(54) HALOMETHYLATED POLYPHENYLENE ETHER AND METHOD FOR THE MANUFACTURE THEREOF

(71) Applicant: SHPP Global Technologies B.V., Bergen op Zoom (NL)

(72) Inventors: Vijay Raghavan, Bangalore (IN); Shubashree Swaminathan, Bangalore (IN); Rajesh Chowdhury, Bangalore (IN); Jaykisor Pal, Bangalore (IN); Shadaksharaswamy Puttamadappa, Bangalore (IN); Debasish Banerjee, Bangalore (IN); Manesh Vs, Tumkur (IN)

(21) Appl. No.: 19/478,002

(22) PCT Filed: Apr. 22, 2024
(86) PCT No.: PCT/IB2024/053917

§ 371 Date: Oct. 23, 2025

(30) Foreign Application Priority Data
Apr. 24, 2023 (EP) 23169594.1

(51) Int. Cl. C08G 65/38

(52) U.S. Cl. CPC C08G 65/38

(57) ABSTRACT

A halomethylated polyphenylene ether includes particular amounts of repeating units of the Formulae (I) (II) (III) wherein X is chlorine or bromine. The halomethylated polyphenylene ether can be particularly well suited for subsequent quaternization. Use of the materials described herein in applications such as ion exchange membranes is also described.

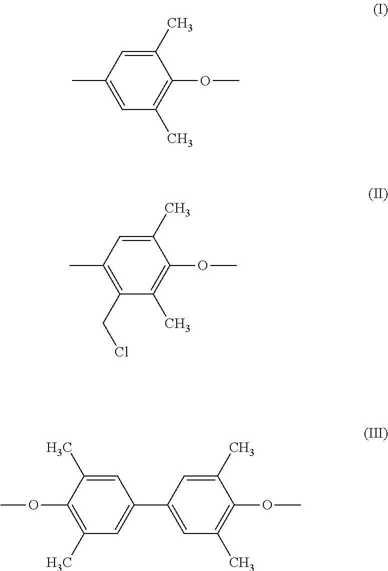

### CROSS REFERENCE TO RELATED APPLICATION

This application claims priority to and the benefit of European Patent Application No. 23169594.1, filed on Apr. 24, 2023, the contents of which are hereby incorporated by reference in their entirety.

### BACKGROUND

Halomethylated polyphenylene ethers (e.g., chloro- and bromomethylated polyphenylene ethers) can be useful in various applications, including electrochemical applications (e.g., battery components). More specifically, halomethylated polyphenylene ethers can be precursors to quaternized polyphenylene ethers which are particularly well suited for use in ion separator membranes in electrochemical devices or fuel cells. Previous methods of preparing halomethylated polyphenylene ethers often provided halomethylated polyphenylene ethers with relatively low degrees of substitution (i.e., less than 30%). Additionally, controlling the uniformity of the halomethylated product (e.g., mono vs. di-substituted, as well as distribution of the functional groups along the polymer backbone) can be difficult.

There remains a need in the art for improved halomethylated polyphenylene ether, specifically chloromethylated and bromomethylated polyphenylene ether. It would be particularly advantageous to provide a chloromethylated or bromomethylated polyphenylene ether with a predetermined degree of chloromethylation or bromomethylation, respectively. It would be a further advantage to provide a chloromethylated or bromomethylated polyphenylene ether having improved uniformity of substitution of the halomethyl groups along the polymer backbone.

### SUMMARY

A halomethylated polyphenylene ether comprises 35 to 89 mole percent of a first repeating unit of formula (I)

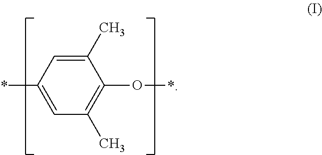

10 to 65 mole percent of a second repeating unit of formula (II)

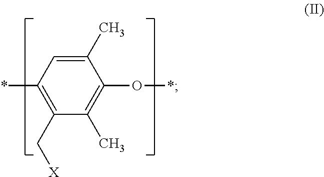

and
1 mole percent or less of a third repeating unit of formula (III)

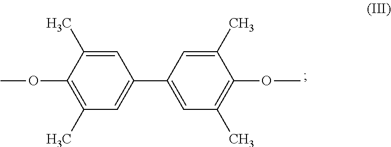

wherein X in Formula (II) is bromine (Br) or chlorine (Cl); wherein at least 90% of halomethylated repeat units are monohalomethylated repeating units of Formula (II), as determined by nuclear magnetic resonance spectroscopy; and wherein the halomethylated polyphenylene ether has a residual zinc content of less than 1000 ppm, based on the total weight of the halomethylated polyphenylene ether.

A method for the manufacture of a halomethylated polyphenylene ether comprises contacting a polyphenylene ether with chloromethyl ethyl ether or bromomethyl methyl ether to provide a mixture comprising the halomethylated polyphenylene ether; and isolating the halomethylated polyphenylene ether from the mixture.

A quaternary-amine containing polyphenylene ether derived from the halomethylated polyphenylene ether represents another aspect of the present disclosure.

An article comprising the halomethylated polyphenylene ether represents another aspect of the present disclosure.

An anion exchange membrane comprising the quaternary amine-containing polyphenylene ether represents another aspect of the present disclosure.

The above described and other features are exemplified by the following detailed description.

### DETAILED DESCRIPTION

The present inventors have discovered that a halomethylated polyphenylene ether can be provided having a desirable combination of features, including a high degree of monohalomethylation (i.e., one halomethyl group per repeat unit). As used herein, the term “halomethylated polyphenylene ether” will be used for simplicity to refer to chloromethylated polyphenylene ether and bromomethylated polyphenylene ether. The halomethylated polyphenylene ethers (e.g., chloromethylated polyphenylene ethers and bromomethylated polyphenylene ethers) provided herein can be used as precursors to their quaternized counterparts and therefore can be particularly well suited for use in ion separator membranes for electrochemical applications.

Accordingly, an aspect of the present disclosure is a halomethylated polyphenylene ether. The halomethylated polyphenylene ether comprises particular amounts of repeating units of the formula (I), (II), and (III)

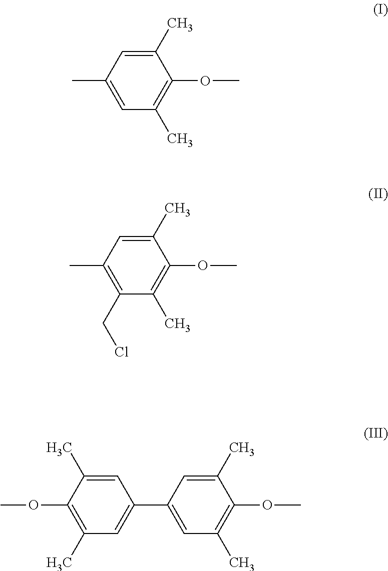

wherein X in Formula (II) is Cl or Br. In an aspect, the halomethylated polyphenylene ether comprises 35 to 89 mole percent, or 55 to 85 mole percent, or 60 to 80 mole percent of the units according to formula (I), 10 to 65 mole percent, or 15 to 45 mole percent, or 30 to 40 mole percent of the units according to formula (II), and 1 mole percent or less of the units according to formula (III).

In an aspect, the halomethylated polyphenylene ether can further comprise repeating units according to any one or more of formulas (IV)-(IX)

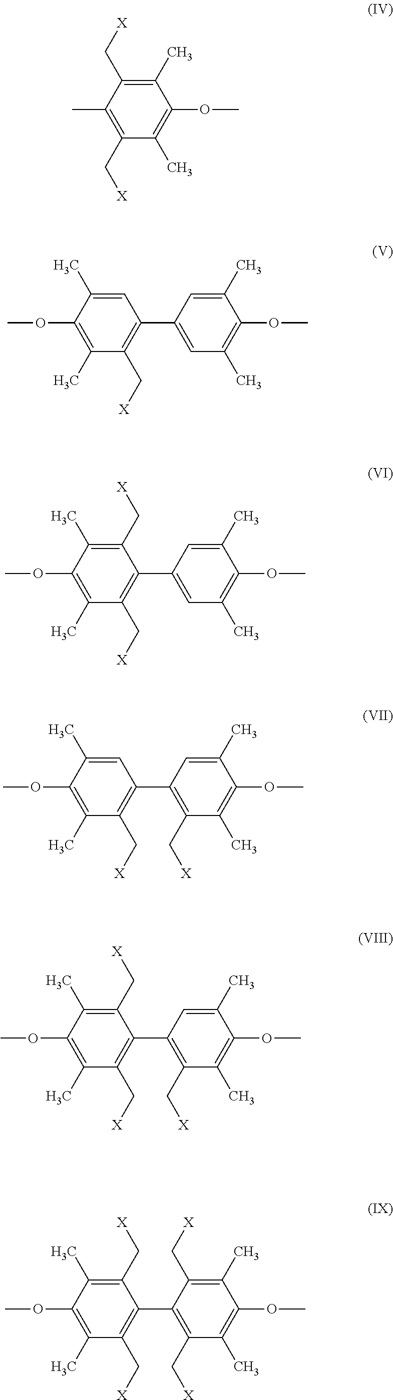

wherein in each of Formulas (IV) to (IX), X is Cl or Br. The repeating units according to formulas (IV)-(IX) can each independently be present in the halomethylated polyphenylene ether in an amount of 1 mole percent or less.

In an aspect, the halomethylated polyphenylene ether comprises particular amounts of repeating units of the formula (I)-(IX). For example, halomethylated polyphenylene ether comprises 35 to 89 mole percent, or 55 to 85 mole percent, or 60 to 80 mole percent of the units according to formula (I), 10 to 65 mole percent, or 15 to 45 mole percent, or 30 to 40 mole percent of the units according to formula (II), and 1 mole percent or less of the units according to formulas (III)-(IX).

In a specific aspect, the halomethylated polyphenylene ether can be a chloromethylated polyphenylene ether and can comprise particular amounts of repeating units of the formula (IA), (IIA), and (IIIA)

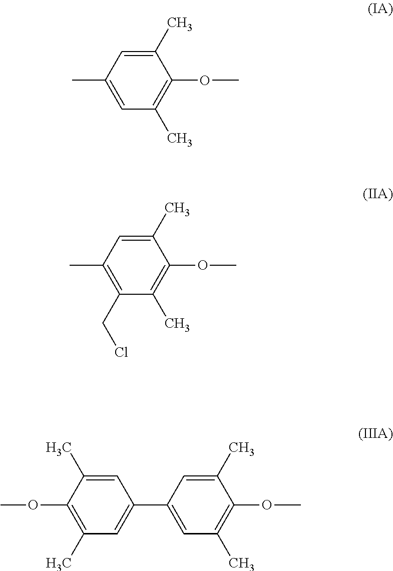

In an aspect, the chloromethylated polyphenylene ether comprises 35 to 89 mole percent, or 55 to 85 mole percent, or 60 to 80 mole percent of the units according to formula (I), 10 to 65 mole percent, or 15 to 45 mole percent, or 30 to 40 mole percent of the units according to formula (II), and 1 mole percent or less of the units according to formula (III).

In an aspect, the chloromethylated polyphenylene ether can further comprise repeating units according to any one or more of formulas (IVA)-(IXA)

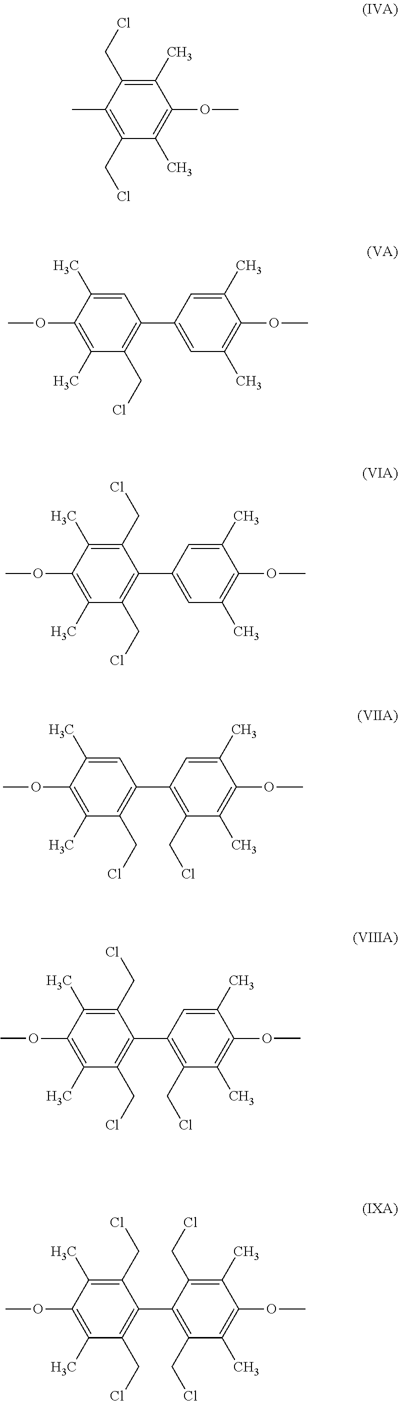

The repeating units according to formulas (IVA)-(IXA) can each independently be present in the chloromethylated polyphenylene ether in an amount of 1 mole percent or less.

In another specific aspect, the halomethylated polyphenylene ether can be a bromomethylated polyphenylene ether and can comprise particular amounts of repeating units of the formula (IB), (IIB), and (IIIB)

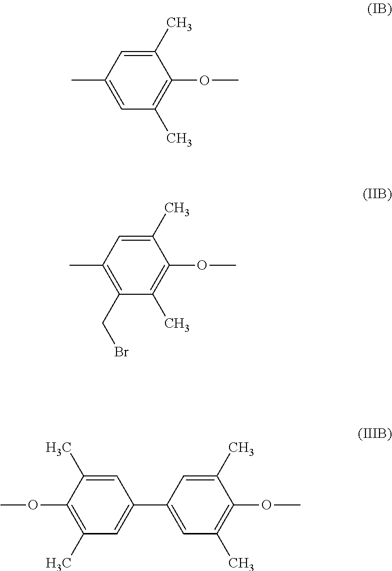

In an aspect, the bromomethylated polyphenylene ether comprises 35 to 89 mole percent, or 55 to 85 mole percent, or 60 to 80 mole percent of the units according to formula (I), 10 to 65 mole percent, or 15 to 45 mole percent, or 30 to 40 mole percent of the units according to formula (II), and 1 mole percent or less of the units according to formula (III).

In an aspect, the bromomethylated polyphenylene ether can further comprise repeating units according to any one or more of formulas (IVB)-(IXB)

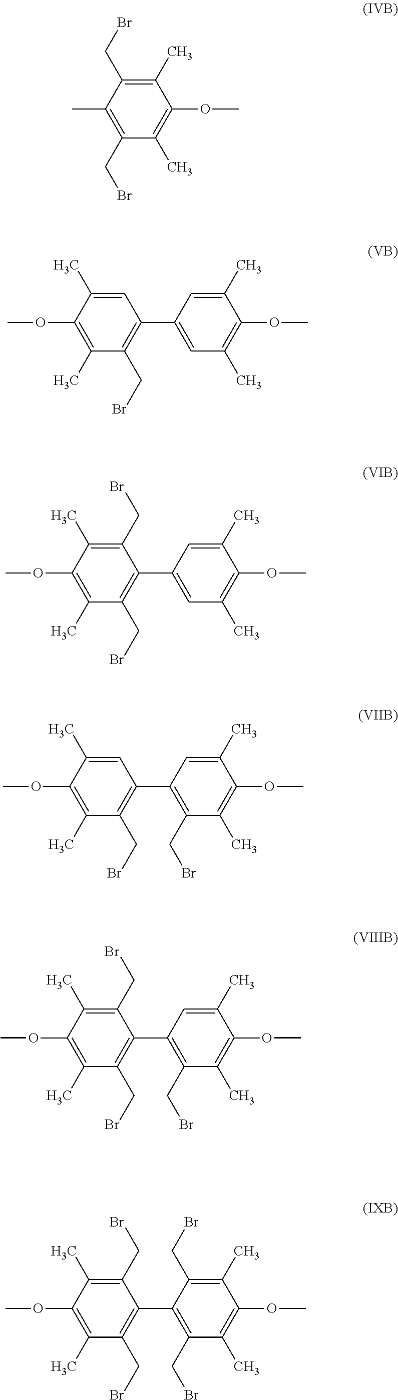

The repeating units according to formulas (IVB)-(IXB) can each independently be present in the bromomethylated polyphenylene ether in an amount of 1 mole percent or less.

The halomethylated polyphenylene ether of the present disclosure has an overall degree of halomethylation (also referred to herein as degree of substitution) of 10 to 70%. Stated another way, 10 to 70% of the repeating units of the halomethylated polyphenylene ether comprise at least one halomethyl group. The total degree of substitution can be determined using nuclear magnetic resonance (NMR) spectroscopy. A method of determining the degree of substitution is further described in the working examples below. Within the range of 10 to 70%, the halomethylated polyphenylene ether of the present disclosure can have an overall degree of halomethylation 20 to 80%, 30 to 70%, or 20 to 70%.

Of the substituted repeat units, at least 90% are monosubstituted or monohalomethylated. Stated another way, at least 90% of the halomethylated repeating units have only one halomethyl group per repeat unit (i.e., are according to formula (II)). In an aspect, at least 92%, or at least 93%, or at least 94%, or 90 to 100%, or 90 to 99%, or 90 to 98%, or 92 to 99%, or 92 to 98% of the halomethylated repeating units are monohalomethylated. It is noted that the term “monosubstituted” as used herein is not equivalent to “uniformly substituted”. The term “uniform substitution” refers to a substituted poly(phenylene ether) product having a certain degree of substitution (e.g., halomethylation) that is uniform throughout the mass of the product. In contrast, “monosubstituted” as used herein means that a halomethylated poly(phenylene ether) product has a certain (uniform) degree of halomethylation across the mass of the product, and further that at least 90% of the repeat units bearing a halomethyl group have only one halomethyl group. For example, a halomethylated poly(phenylene ether) product having a uniform degree of substitution of 20% means that the degree of substitution is 20% across the entire mass of the product. In the present application, a monohalomethylated poly(phenylene ether) product having a degree of substitution of 20% means that, for example, out of the 20 repeat units which are halomethylated (assuming 100 repeat units total in the polymer for ease of calculation), at least 90% of those 20 repeat units have only one halomethyl group (i.e., at least 18 of the 20 repeat units have one halomethyl group). In an aspect, the ratio of monochloromethylated to dichloromethylated polyphenylene ether repeating units is greater than 0.94.

The distribution of the halomethylated repeating units (i.e., formulas (II) and (IV)-(IX)) and the non-halomethylated repeating units (i.e., formula (I)) can be random or block-like, where block-like refers to “clusters” of adjacent halomethylated repeating units or halomethylated repeating units in close proximity. In an aspect, adjacent halomethylated repeating units or halomethylated repeating units in close proximity can constitute a majority of the halomethylated repeating units. For example, adjacent halomethylated repeating units or halomethylated repeating units in close proximity can constitute at least 80%, or at least 85%, or at least 90% of the total amount of the halomethylated repeating units. The halomethylated polyphenylene ether can also comprise random arrangements of the repeating units, where a halomethylated repeating unit is not adjacent or in close proximity to another halomethylated repeating unit. In an aspect, isolated halomethylated repeating units can constitute less than 20%, or less than 15%, or less than 10%, or less than 5%, or less than 1%, or less than 0.5%, or less than 0.1% of the total amount of the halomethylated repeating units.

The halomethylated polyphenylene ether can have a weight average molecular weight of least 40,000 grams per mole. Molecular weight can be determined by gel permeation chromatography eluting with chloroform and relative to polystyrene standards. Within this range, the halomethylated polyphenylene ether can have a weight average molecular weight of 40,000 to 150,000 grams per mole.

The halomethylated polyphenylene ether can have a low oligomer content. For example, the halomethylated polyphenylene ether can have less than 2 weight percent, or less than 1.5 weight percent, or less than 1.3 weight percent of a phenylene ether oligomer having a weight average molecular weight of less than 1,000 grams per mole, wherein weight percent is based on the total weight of the halomethylated polyphenylene ether. The halomethylated polyphenylene ether can have less than 1 weight percent, or less than 0.95 weight percent, or less than 0.92 weight percent, or less than 0.90 weight percent of a phenylene ether oligomer having a weight average molecular weight of less than 500 grams per mole, wherein weight percent is based on the total weight of the halomethylated polyphenylene ether.

A method of making the halomethylated polyphenylene ether represents another aspect of the present disclosure. In an aspect, the method comprises contacting a polyphenylene ether with chloromethyl ethyl ether to provide a chloromethylated polyphenylene ether. In another aspect, the method comprises contacting a polyphenylene ether with bromomethyl methyl ether to provide a bromomethylated polyphenylene ether.

The polyphenylene ether starting material can be a polyphenylene ether of the formula

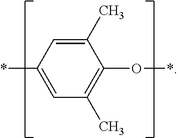

Providing the halomethylated polyphenylene ether can be at a temperature of 25 to 75° C., or 30 to 70° C., or greater than 30 to less than 70° C., or greater than 30 to 65° C., or 40 to 60° C., or 45 to 55° C., and a time of 1 to 10 hours, or 2 to 6 hours. In an aspect, the reaction time may be less than 5 hours, for example 1 to less than 5 hours. The contacting of the polyphenylene ether with chloromethyl ethyl ether or bromomethyl methyl ether can be in the presence of a solvent, preferably an organic solvent selected to dissolve the polyphenylene ether. Exemplary solvents can include halogenated aromatic solvents such as chlorobenzene or ortho-dichlorobenzene. The polyphenylene ether starting material and the solvent can be present in amounts effective to provide a solution having 5 to 25 weight percent, or 10 to 25 weight percent, or 12 to 25 weight percent, or 10 to 20 weight percent, or 12 to 20 weight percent, or 12 to 18 weight percent of the polyphenylene ether, based on the total weight of the polyphenylene ether and the solvent. The contacting can include using a polyphenylene ether:chloromethyl ethyl etber molar ratio or a polyphenylene ether:bromomethyl methyl ether molar ratio of 1.9:1 to 2.1:1, preferably 1.95:1 to 2.05:1, or 1.99:1 to 2.01:1, most preferably 2:1.

The contacting of the polyphenylene ether with chloromethyl ethyl ether or bromomethyl methyl ether can be in the presence of a catalyst to provide the chloromethylated polyphenylene ether or bromomethylated polyphenylene ether, respectively. In an aspect, the catalyst can be a Lewis acid catalyst, for example a zinc-containing catalyst. In a specific aspect, the catalyst can be zinc chloride (ZnCl₂). The catalyst can be present in an amount of 1 to 10 weight percent, or 2 to 7 weight percent, or 3 to 7 weight percent, or 4 to 6 weight percent, based on the weight of the polyphenylene ether starting material. In an aspect, the reaction mixture including the catalyst is homogenous. For example, the homogeneous reaction mixture can be obtained by pre-dissolving the catalyst in a suitable solvent prior to addition to the reaction mixture. For example, the catalyst can be pre-dissolved in a solvent such as a dialkoxymethane (e.g., diethoxymethane or the like) as further described in the working examples below. Without wishing to be bound by theory, it is believed that heterogenous reaction mixtures (e.g., including insoluble catalyst) can lead to reproducibility issues and increased amounts of residual catalyst in the product. In an aspect, the catalyst can be added to the reaction mixture as a powder.

In some aspects, the chloromethyl ethyl ether or bromomethyl methyl ether can be added using a pump to obtain a uniform rate of addition. In some aspects, the chloromethyl ethyl ether or bromomethyl methyl ether can be added in 45 minutes or less, preferably 30 minutes or less, preferably 25 minutes or less, or 20 minutes or less, or 15 minutes or less. Addition of chloromethyl ethyl ether or bromomethyl methyl ether over longer periods of time (e.g., 30 minutes or more, or 45 minutes or more) or by manual addition methods can lead to loss of control over molecular weight and degree of substitution.

The method can further comprise isolating the halomethylated polyphenylene ether from the reaction mixture comprising the halomethylated polyphenylene ether. Isolation can include one or more of precipitating the halomethylated polyphenylene ether from the mixture in an antisolvent, preferably methanol or methanolic hydrochloric acid; washing the halomethylated polyphenylene ether, preferably with water, aqueous hydrochloric acid, or a combination thereof; or adding a chelating agent, an ion exchange resin, carbon, or a combination thereof to the mixture. In an aspect, isolating the halomethylated polyphenylene ether can comprise precipitating the halomethylated polyphenylene ether from the mixture in an antisolvent, and washing the halomethylated polyphenylene ether. The antisolvent can comprise methanol or methanolic hydrochloric acid and the washing can be with water, aqueous hydrochloric acid, or a combination thereof. In an aspect, the antisolvent does not comprise water. In an aspect, washing the halomethylated polyphenylene ether does not comprise washing with water. In an aspect, isolating the halomethylated polyphenylene ether can comprise precipitating the halomethylated polyphenylene ether from the mixture in an antisolvent, isolating the precipitate by any solid-liquid separation technique (e.g., filtration), and redissolving the filtered halomethylated polyphenylene ether, for example in chlorobenzene or ortho-dichlorobenzene, optionally further comprising a dialkoxymethane (e.g., chlorobenzene comprising a dialkoxymethane such as dimethoxymethane or diethoxymethane or ortho-dichlorobenzene comprising a dialkoxymethane such as dimethoxymethane or diethoxymethane). A chelating agent can be added to the halomethylated polyphenylene ether solution. The halomethylated polyphenylene ether can be reprecipitated, isolated, and optionally washed.

Exemplary methods for the manufacture and isolation of the halomethylated polyphenylene ether are further described in the working examples below.

Advantageously, the halomethylated polyphenylene ether can have low levels of residual catalyst. For example, the halomethylated polyphenylene ether can have a residual catalyst content of less than 1000 ppm, or less than 500 ppm, or less than 100 ppm, or less than 50 ppm, or less than 20 ppm, each based on the total weight of the halomethylated polyphenylene ether. In an aspect, the halomethylated polyphenylene ether can be prepared using a zinc-containing catalyst, and the resulting halomethylated polyphenylene ether can have a residual zinc content of less than 1000 ppm, or less than 500 ppm, or less than 100 ppm, or less than 50 ppm, or less than 20 ppm, each based on the total weight of the halomethylated polyphenylene ether. Residual catalyst content can be determined, for example by inductively coupled plasma optical emission spectroscopy or inductively coupled plasma mass spectrometry.

The present inventors have also found that various dialkoxyalkanes (e.g., dialkoxymethanes such as diethoxymethane and dimethoxymethane) can form as a side product during the reaction and/or precipitation stages of the method of making the halomethylated polyphenylene ether. The halomethylated polyphenylene ether according to the present disclosure can have a dialkoxyalkane content of less than 20 ppm, or less than 10 ppm, each based on the total weight of the halomethylated polyphenylene ether. In an aspect, the halomethylated polyphenylene ether can have a combined diethoxymethane and dimethoxymethane content of less than 20 ppm, or less than 10 ppm, each based on the total weight of the halomethylated polyphenylene ether. Residual dialkoxyalkane content can be determined, for example, by nuclear magnetic resonance (NMR) spectroscopy or head space gas chromatography (GC-HS).

Halomethylated polyphenylene ether according to the present disclosure can be useful as a precursor to form the corresponding quaternary amine-containing polyphenylene ethers. Accordingly, a quaternary-amine containing polyphenylene ether derived from the halomethylated polyphenylene ether described herein represents another aspect of the present disclosure.

A quaternized polyphenylene ether can comprise repeating units of the formula

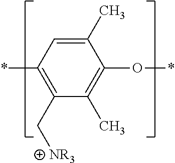

wherein each occurrence of R is independently a C₁₋₁₂ alkyl group, for example a methyl group. The quaternized polyphenylene ether can have an overall net position charge due to the presence of the quaternary ammonium groups. In an aspect, the quaternized polyphenylene ether can further comprise repeating units according to any of Formulas (I) and (III)-(IX) wherein each X has been substituted with the —NR₃ group. The amounts of the respective repeating units can be as described above for the halomethylated precursors.

The quaternized polyphenylene ether can be made by any suitable method for substituting a halo group with an amine. For example, the halomethylated polyphenylene ether can be dissolved in a solvent, and contacted with a trialkylamine (e.g., trimethylamine) to provide the quaternized polyphenylene ether. Exemplary synthetic procedures for preparing a quaternized polyphenylene ethers can be found in Int. J. Mol. Sci. 2019, 20, 3678, the contents of which is hereby incorporated by reference in its entirety for all purposes.

The quaternized polyphenylene ether of the present disclosure can have an overall degree of quaternary amine substitution of 10 to 70%. Stated another way, 10 to 70% of the repeating units of the quaternized polyphenylene ether comprise at least one quaternary amine group. The total degree of substitution can be determined using nuclear magnetic resonance (NMR) spectroscopy. Within the range of 10 to 70%, the overall degree of quaternary amine substitution can be 20 to 80%, or 30 to 70%, or 20 to 70%.

Of the substituted repeat units, at least 90% of the quaternized repeating units can have one quaternary amine group per repeat unit. In an aspect, at least 92%, or at least 93%, or at least 94%, or 90 to 100%, or 90 to 99%, or 90 to 98%, or 92 to 99%, or 92 to 98% of the quaternized repeating units are mono-quaternized.

The chloromethylated polyphenylene ethers or the corresponding quaternized derivatives can be used to form various articles. For example, the chloromethylated polyphenylene ethers or the corresponding quaternized derivatives can be molded into articles, for example by injection molding or extrusion.

The chloromethylated polyphenylene ethers and in particular the corresponding quaternized derivatives can be useful in various application, for example electrochemical device applications. In a specific aspect, the quaternized polyphenylene ethers according to the present disclosure can be particularly useful for forming membranes, specifically ion exchange membranes. Membranes can be prepared, for example, by dissolving the quaternized polyphenylene ether in a suitable solvent and casting the solution to provide a film.

This disclosure is further illustrated by the following examples, which are non-limiting.

### EXAMPLES

Chloromethylated poly(phenylene ether) s were prepared according to the following examples. The same general procedure described herein would be applicable to the bromomethylated polyphenylene ether of the present disclosure.

Chloromethylated poly(phenylene ether) was prepared according to the following general procedure. Chloromethylated poly(phenylene ether) with degrees of substitution ranging from 36 to 65% was synthesized by introducing chloromethyl ethyl ether (CMEE, 2 equivalents) to a 15 weight percent poly(phenylene ether) solution in chlorobenzene or ortho-dichlorobenzene at 30-50° C. (based on solvent weight) and containing 5 wt % ZnCl (based on the amount of poly(phenylene ether)) over 15 to 45 minutes. The initial poly(phenylene ether) was a poly(2,6-dimethyl-1,4-phenylene ether) having an intrinsic viscosity of 0.46 deciliters per gram as measured in chloroform at 25° C. using an Ubbelohde viscometer. The reaction was continued for 4.5 hours at temperatures in the range of 30-70° C. Table 1 summarizes the specific conditions and reactant quantities for each example.

TABLE 1

| | | | | ZnCl₂ | | | |
|---|---|---|---|---|---|---|---|
| | PPE | | | (wt % based | Addition | Addition | Reaction |
| Ex. | (g) | Reactant | Solvent | on PPE) | T (° C.) | Time (min) | T (° C.) |
| 1 | 32 | CMEE | Chlorobenzene | 5 | 30 | 15 | 30 |
| | | | | | | (used | |
| | | | | | | pump) | |
| 2 | 32 | CMEE | Chlorobenzene | 5 | 50 | 20 | 50 |
| | | | | | | (used | |
| | | | | | | pump) | |
| 3-7, | 32 | CMEE | Chlorobenzene | 5 | 50 | 15 | 50 |
| 17-19 | | | | | | (used | |
| | | | | | | pump) | |
| 8 | 64 | CMEE | Chlorobenzene | 5 | 30 | 15 | 50 |
| | | | | | | (used | |
| | | | | | | pump) | |
| 9 | 64 | CMEE | Chlorobenzene | 5 (pre dissolved | 30 | 15 | 50 |
| | | | | in 5 g | | (used | |
| | | | | diethoxymethane) | | pump) | |
| 10 | 64 | CMEE | Chlorobenzene | 5 | 50 | 45 | 50 |
| | | | | | | (used | |
| | | | | | | pump) | |
| 11 | 2 | CMEE | Chlorobenzene | 5 | 70 | 45 | 70 |
| | | | | | | (manual) | |
| 12 | 2 | CMEE | ODCB | 5 | 50 | 15 | 50 |
| | | | | | | (manual) | |
| 13-16*² | — | — | — | — | — | — | — |
| 20-23 | 16 | CMEE | Chlorobenzene | 5 | 50 | 15 | 50 |
| | | | | | | (used | |
| | | | | | | pump) | |

*²For examples 13-16, sample from example 8 was used.

At the conclusion of the reaction, the polymer was precipitated. Precipitation conditions for each example were as follows.

Example 1: The reaction was quenched by adding 50 mL of 2 M HCl. The chloromethylated polyphenylene ether resin was precipitated in 700 g of methanol. The precipitate was filtered, air dried and dissolved in 100 mL of chlorobenzene to which 10 mL of dimethoxymethane and 30 mL of 2 M HCl was introduced. The polymer was re-precipitated in 700 g of methanol. The previously mentioned step involving re-dissolution and re-precipitation was repeated one more time. The polymer was filtered and washed with 150 mL of 2 M HCl twice under stirring conditions at 50° C. for 2 hours. The polymer was filtered and washed again with water twice and 50° C. for 2 hours under stirring conditions. The polymer was finally washed with 100 mL methanol. The polymer was filtered and air-dried for 24 hours.

Example 2: The reaction was precipitated in 364 g of methanol. The polymer was filtered and washed with 150 mL of 1 M HCl twice under stirring conditions at 50° C. for 2 hours. The polymer was filtered and washed again with water twice and 50° C. for 2 hours under stirring conditions. The polymer was finally washed with 100 mL methanol. The polymer was filtered and air-dried for 24 hours.

Example 3: The reaction was quenched by adding 30 mL of 2 M HCl. The polymer was precipitated in 700 g of methanol. The precipitate was filtered, air dried and dissolved in 100 mL of chlorobenzene to which 30 mL of 2 M HCl was introduced. The polymer was re-precipitated in 700 g of methanol. The previously mentioned step involving re-dissolution and re-precipitation in methanol was repeated one more time. The polymer was filtered and washed with 150 mL of 2 M HCl twice under stirring conditions at 50° C. for 2 hours. The polymer was filtered and washed again with water twice and 50° C. for 2 hours under stirring conditions. The polymer was finally washed with 100 mL methanol. The polymer was filtered and air-dried for 24 hours.

Example 4: The polymer was precipitated in 364 g of methanol. The polymer was filtered and washed with 150 mL of 1 M HCl twice under stirring conditions at room temperature for 2 hours. The polymer was filtered and washed again with water twice and room temperature for 2 hours under stirring conditions. The polymer was finally washed with 100 mL methanol. The polymer was filtered and air-dried for 24 hours.

Examples 5, 6: The reaction quenched with 10 mL of 1 M HCl and then precipitated in 364 g of methanol. The polymer was filtered and washed with 150 mL of 1 M HCl twice under stirring conditions at 50° C. for 2 hours. The polymer was filtered and washed again with 150 mL of water twice at 50° C. for 2 hrs under stirring condition. The polymer was finally washed with 100 mL methanol at 50° C. The polymer was filtered and air-dried for 24 hours.

Example 7: The polymer was precipitated in 364 g of methanol. The precipitate was filtered, air dried and dissolved in 100 mL of chlorobenzene. 3 wt % nitriloacetic acid (NTA) in 25 mL water was added to the polymer solution and stirred gently for 15 minutes. 364 g of methanol introduced dropwise. The polymer precipitated as fine powder. The polymer was filtered and washed with 150 mL of water under stirring conditions at 50° C. for 2 hours. The polymer was finally washed with 100 mL methanol. The polymer was filtered and air-dried for 24 hours.

Example 8: The reaction was quenched with 20 mL of 2 M HCl and then precipitated in 728 g of methanol. The polymer was filtered and air dried. The polymer was re-dissolved in 200 mL of chlorobenzene, to which 20 mL 2 M HCl was introduced. The polymer solution was re-precipitated in 728 g of methanol. The precipitate was washed with 300 mL of 2 M HCl twice under stirring conditions at 50° C. for 2 hours. The polymer was filtered and washed again with 300 mL of water twice and 50° C. for 2 hours under stirring condition. The polymer was finally washed with 200 mL methanol at 50° C. The polymer was filtered and air-dried for 24 hours.

Examples 9, 10: Precipitation/purification were done in the same manner as in example 3, but with twice the volume of all the solvents.

Examples 11, 12: The polymer was precipitated in 50 mL of methanol. The polymer was air dried for 24 hrs.

Example 13: The sample from Example 8 was dried at 65° C. for additional 5 hours.

Example 14: The sample from Example 8 was dried at 65° C. for 1 day.

Example 15: The sample from Example 8 was dried at 65° C. for 2 days.

Example 16: The sample from Example 8 was dried at 65° C. for 5 days.

Example 17: The polymer was precipitated in 182 g of 1M methanolic HCL. The polymer was filtered and washed with 75 mL of 1 M HCl twice under stirring conditions at RT for 2 hours. The polymer was filtered and washed again with water twice at room temperature for 2 hours under stirring conditions. The polymer was finally washed with 50 mL methanol. The polymer was filtered and air-dried for 24 hours.

Example 18: Precipitation/purification were done in the same manner as in Example 8, but the solvents were used in amounts 75% less than in Example 8.

Example 19: Precipitation/purification were done in the same manner as in Example 3, but the solvents were used in amounts 50% less than in Example 3.

Example 20: The chloromethylated poly(phenylene ether) polymer was quenched by adding 10 mL of 2 M HCl. The polymer then was precipitated in 364 g of ethanol. The precipitate was filtered, air dried and dissolved in 100 mL of chlorobenzene containing 10 mL of dicthoxymethane to which 25 mL of 2 M HCl was added dropwise. Ethanol (364 grams) was then introduced dropwise and the polymer precipitated as a fine powder. The polymer was filtered and washed with 150 mL of 2 M HCl twice under stirring conditions at 50° C. for 2 hours. The polymer was filtered and washed again with water twice and 50° C. for 2 hours under stirring condition. The polymer was finally washed with 100 mL methanol. The polymer was filtered and air-dried for 24 hours. The sample was then dried in oven for 5 hours at 60° C.

Example 21: The polymer was precipitated in 182 g of methanol. The polymer was washed with 100 mL methanol. The polymer was filtered and air-dried for 24 hours.

Example 22: The polymer was precipitated in 22 g of methanol. The precipitate was filtered, air dried and dissolved in 7 mL of chlorobenzene to which 2 mL of water introduced. 3 wt % ion exchange resin (IER) was added to the polymer solution and stirred gently for 8 hours. 22 g of methanol introduced dropwise. The polymer precipitated as fine powder. The polymer was filtered and washed with 10 mL of water under stirring conditions at 50° C. for 2 hours. The polymer was finally washed with 10 mL methanol. The polymer was filtered and air-dried for 24 hours.

Example 23: The polymer was precipitated in 22 g of methanol. The precipitate was filtered, air dried and dissolved in 7 mL of chlorobenzene to which 2 mL of water introduced. 3 wt % activated carbon was added to the polymer solution and stirred gently for 8 hours. 22 g of methanol introduced dropwise. The polymer precipitated as fine powder. The polymer was filtered and washed with 10 mL of water under stirring conditions at 50° C. for 2 hours. The polymer was finally washed with 10 mL methanol. The polymer was filtered and air-dried for 24 hours.

The resulting chloromethylated poly(phenylene) ethers were characterized using proton nuclear magnetic resonance (¹H NMR) spectroscopy and gel permeation chromatography (GPC) was used to characterize the oligomer content of various polymer samples. GPC was performed eluting with chloroform containing 50 ppm of DBA, and molecular weight was determined relative to polystyrene standards.

¹H NMR spectroscopy was used to characterize the ratio of mono:di substituted chloromethylated phenylene ether repeating units and the total degree of substitution (DS).

¹H-¹³C heteronuclear single quantum coherence NMR (HSQC NMR) was used to characterize the relative position of the chloromethylated repeating units relative to one another. For example, the presence of a peak at 4.92 ppm (¹H)/38.23 ppm (¹³C) ppm can correspond to chloromethylated repeating units which are adjacent or in close proximity to one another (hereinafter referred to as the “major component”). The corresponding degree of substitution (DS %) of the major component is referred to as “major DS %”. In contrast, the presence of a peak at 4.72 ppm (¹H)/65.52 ppm (¹³C) ppm can correspond to a chloromethylated repeating unit which is not adjacent or in close proximity to another chloromethylated repeating unit (hereinafter referred to as the “minor component”). The corresponding DS % of the minor component is referred to as “minor DS %”).

Characterization of chloromethylated poly(phenylene ether) according to Examples 1-23 is shown in Table 2.

TABLE 2a

| | E1 | E2 | E3 | E4 | E5 | E6 | E7 | E8 | E9 | E10 | E11 |
|---|---|---|---|---|---|---|---|---|---|---|---|
| Total | 36.63 | 39.36 | 40.53 | 41.58 | 41.65 | 41.84 | 41.84 | 42.64 | 46.7 | 49.14 | 63.82 |
| DS % | | | | | | | | | | | |
| Major DS % | 29.49 | 38.35 | 39.51 | 40.33 | 39.32 | 40.79 | 40.59 | 38.38 | 41.23 | 48.4 | 60.53 |
| Minor DS % | 7.14 | 1 | 1.02 | 1.25 | 2.33 | 1.05 | 1.26 | 4.26 | 5.47 | 0.74 | 3.29 |
| Monosubs. | 1 | 0.98 | 1 | 1 | 1 | 0.99 | 0.98 | 1 | 0.94 | 1 | 0.97 |
| Ratio¹ | | | | | | | | | | | |
| MeOH to | 0.48 | NA | 0.4 | 0.36 | 0.42 | 0.35 | 0.36 | 0.43 | 0.45 | 0.31 | NA |
| minor | | | | | | | | | | | |
| component | | | | | | | | | | | |
| Molar ratio | | | | | | | | | | | |
| Zn | <0.5 | | 9.5 | 282 | 96 | 70 | 6.19 | 20.24 | | | |
| (ppm) | | | | | | | | | | | |
| Moisture | | | | | | | | 0.31 | | | |
| (wt %) | | | | | | | | | | | |
| DMM (ppm) | <10 ppm | | | | | | | | | | |
| DEM (ppm) | <10 ppm | | | | | | | | | | |
| MeOH (ppm) | 90 | | | | | | | | | | |
| EtOH (ppm) | <10 | | | | | | | | | | |
| ClBz (ppm) | 12192 | | | | | | | | | | |
| Mn | 16707 | 24359 | 23520 | 17162 | 19123 | 17144 | 21790 | 19195 | 18271 | 23873 | 26567 |
| Mw | 61823 | 67983 | 63632 | 56575 | 60007 | 59135 | 62451 | 61210 | 75241 | 76803 | 132792 |
| PDI | 3.7 | 2.8 | 2.7 | 3.3 | 3.1 | 3.4 | 3.3 | 3.2 | 4.1 | 3.2 | 5 |
| <1 kDa | 1.26 | | | 1.04 | | 1 | | | 1.14 | | |
| (wt %) | | | | | | | | | | | |
| <500 Da | 0.87 | | | 0.72 | | 0.68 | | | 0.8 | | |
| (wt %) | | | | | | | | | | | |

TABLE 2b

| | E12 | E13 | E14 | E15 | E16 | E17 | E18 | E19 | E20 | E21 | E22 | E23 |
|---|---|---|---|---|---|---|---|---|---|---|---|---|
| Total DS % | 65 | 42.89 | 43.1 | 42.11 | 42.64 | 42 | 44 | 44 | 35 | 43.9 | 42 | 42 |
| Major DS % | 59.67 | 38.91 | 38.79 | 38.11 | 38.38 | | | | | | | |
| Minor DS % | 5.33 | 3.97 | 4.31 | 4 | 4.26 | | | | | | | |
| Monosubs. | 0.97 | 0.97 | 1 | 0.97 | 1 | | | | | | | |
| Ratio¹ | | | | | | | | | | | | |
| MeOH to | 0.4 | 0.45 | 0.44 | 0.47 | 0.45 | | | | | | | |
| minor | | | | | | | | | | | | |
| component | | | | | | | | | | | | |
| Molar ratio | | | | | | | | | | | | |
| Zn | | | | | | 309 | 37.3 | 8.2 | | 1743 | 2.2 | 1.1 |
| (ppm) | | | | | | | | | | | | |
| Moisture | | | | | | | | | | | | |
| (wt %) | | | | | | | | | | | | |
| DMM (ppm) | | | | | | | | | <10 | | | |
| DEM (ppm) | | | | | | | | | <10 | | | |
| MeOH | | | | | | | | | 96 | | | |
| (ppm) | | | | | | | | | | | | |
| EtOH (ppm) | | | | | | | | | 16 | | | |
| ClBz (ppm) | | | | | | | | | 12578 | | | |
| Mn (Da) | 24135 | NA | 12762 | 13550 | 14352 | 18227 | 19931 | 17501 | 18247 | 23065 | 28286 | 20705 |
| Mw (Da) | 91334 | NA | 54198 | 48540 | 58049 | 61780 | 60570 | 62085 | 49702 | 61147 | 71655 | 57867 |
| PDI | 3.8 | NA | 4.2 | 3.6 | 4 | 3.4 | 3 | 3.5 | 2.7 | 2.7 | 2.5 | 2.8 |
| <1 kDa | | | | | | 0.97 | 0.91 | 1.03 | | | | |
| (wt %) | | | | | | | | | | | | |
| <500 Da | | | | | | 0.69 | 0.65 | 0.72 | | | | |
| (wt %) | | | | | | | | | | | | |

¹Monsubs. ratio = (I₂/2)/I₁ where I₂ = integral value of CH₂ in chlormethyl group attached to phenyl ring at ~4.9 ppm and I₁ = integral value of H of phenyl group meta to the chlormethylated group at ~6.15 ppm. The Monosubs. ratio describes the fraction of the substituted rings in which only one (of the two available protons) is substituted by the chlormethylated group. A monsubs ratio = 1 means only one chloromethyl group is present on a phenyl ring (i.e., is monosubstituted). A monsubs ratio = 0.94 means 94% is monosubstituted and 6% is disubstituted, based on NMR.

As shown in Table 2, chloromethylated poly(phenylene ether) was obtained having a DS in the range of 35 to 65%. Further, the chloromethylated poly(phenylene ether) s exhibited a monosubstituted:disubstituted ratio of greater than 0.94, and the major component was present in an amount of greater than 72%. Since the monosubstitution ratio in all the examples (Table 2a and 2b) was greater than 0.94, the major and minor components are predominantly monosubstituted. Stated another way, regardless of how the substituted repeating units are clustered together (or not), the chloromethylated repeating units are predominantly monosubstituted.

Examples 3-7 and 17-19 illustrate the reproducibility and consistency in the degree of substitution of the product when a controlled addition using a pump over a particular period of time was used. In contrast, manual addition led to some variability in the product.

Example 9 illustrates the benefit of addition of catalyst which as been pre-dissolved in a solvent. Pre-dissolution of the catalyst led to a homogenous reaction mixture, allowing for the desired degree of substitution to be achieved in a shorter amount of time (i.e., 3.5 hours instead of 4.5 hours as in other examples). This pre-dissolution also led to the ability to repeatably and reproducibly obtain the desired product.

It was also observed that despite various drying conditions, small amounts of the precipitation solvent (methanol) remained in the samples, indicating a strong association of the methanol with the minor component. For example, the polymer according to Example 8 exhibited a methanol:minor component molar ratio of 0.43, and even after drying at 65° C. for 5 days (as in Example 16), the methanol:minor component ratio remained at 0.45.

Table 2 further shows that the polymers of Examples 1 and 20 were characterized using GS-MS and ¹H NMR to determine the concentration of organic residuals, specifically dimethoxymethane (DMM), diethoxyethane (DEM), methanol (McOH), ethanol (EtOH), and chlorobenzene (CIBz). It is noted that both GC-MS and NMR indicated the in situ formation of dialkoxymethanes such as DMM and DEM during the reaction and/or precipitation stages. It is also noted that ethanol is a side product of the reaction.

Samples were also characterized for the presence of residual zinc (i.e., from the catalyst), as shown in Table 2. From Table 2, it can be seen that the amount of residual zinc was somewhat affected by the precipitation and washing conditions. For example, the residual zinc content could be reduced to less than 0.5 ppm when the polymer was purified as in Example 1.

It can also be seen from Table 2 that the molecular weight of the final chloromethylated poly(phenylene ether) can be sensitive to the rate of addition of the CMEE reactant.

The effect of the solvent selected for the chloromethylation reaction was also studied. Ortho-dichlorobenzene (ODCB), 1,2-dichloroethane (EDC), and toluene were tested. Chlorobenzene (CB) was found to be preferred, and was used in the foregoing examples. Toluene underwent parallel chloromethylation, leading to a lower degree of substitution of the polyphenylene ether. 1,2-Dichloroethane resulted in formation of a gelled material in the presence of the catalyst. The results of these experiments are shown in Table 3. Molecular weight and DS % were characterized as described above.

TABLE 3

| | | | Catalyst | | | | | | | | |
|---|---|---|---|---|---|---|---|---|---|---|---|
| | | Solvent | (5 wt %, | | | | | | | | |
| | Reactant | (85 wt % | based on | T | Addition/ | Drying | Product | | | | |
| Ex. | (mol eq) | soln) | PPE) | (° C.) | Time | conditions | Form | Mn | Mw | PDI | DS % |
| 24* | CMEE | Toluene | ZnCl₂ | 50 | Pump | room | powder | 22,000 | 53,300 | 2.4 | 13.76 |
| | (2 eq) | | | | (15 min) | temperature; | | | | | |
| | | | | | | overnight | | | | | |
| 25* | CMEE | EDC | ZnCl₂ | 50 | Pump | room | gel | 19,300² | 145,000² | 7.5² | — |
| | (2 eq) | | | | (15 min) | temperature; | | | | | |
| | | | | | | overnight | | | | | |
| 26* | CMEE | EDC | ZnCl₂ | 50 | Pump | room | gel | — | — | — | — |
| | (2 eq) | | | | (15 min) | temperature; | | | | | |
| | | | | | | overnight | | | | | |
| 27* | CMEE | EDC | SnCl₄ | 50 | Manual | room | gel | — | — | — | — |
| | (2 eq) | | | | (30 mins) | temperature; | | | | | |
| | | | | | | overnight | | | | | |
| 28* | CMEE | ODCB | ZnCl₂ | 50 | Pump | room | powder | 23,500 | 108,400 | 4.6 | 61.9 |
| | (2 eq) | | | | (15 min) | temperature; | | | | | |
| | | | | | | overnight | | | | | |
| 29* | CMEE | ODCB | ZnCl₂ | 50 | Pump | room | powder | 16,900 | 124,500 | 4.6 | 52.6 |
| | (2 eq) | | | | (15 min) | temperature; | | | | | |
| | | | | | | overnight | | | | | |
| 30* | CMEE | ODCB | ZnCl₂ | 50 | Manual | room | NS¹ | — | — | — | — |
| | (2 eq) | | | | (30 mins) | temperature; | | | | | |
| | | | | | | overnight | | | | | |

*Denotes a comparative example;
¹Not soluble in chloroform;
²molecular weight and PDI determined from the soluble fraction in chloroform

The effect of the addition method of the CMEE reactant to the reaction mixture was also studied. The use of an addition funnel and a pump was tested. The addition funnel generally led to less control over the molecular weight and the DS % of the chloromethylated polyphenylene ether product. Results from manual addition using an addition funnel are summarized in Table 4.

TABLE 4

| | | | Catalyst | | | | | | | | |
|---|---|---|---|---|---|---|---|---|---|---|---|
| | | Solvent | (5 wt %, | | | | | | | | |
| | Reactant | (85 wt % | based on | T | Addition, | Drying | Product | | | | |
| Ex. | (mol eq) | soln) | PPE) | (° C.) | Time | conditions | Form | Mn | Mw | PDI | DS % |
| 31* | CMEE | CB | ZnCl₂ | 50 | Manual, | room | powder | 12,200 | 47,000 | 3.9 | 55 |
| | (2 eq) | | | | 15 min | temperature; | | | | | |
| | | | | | | overnight | | | | | |
| 32* | CMEE | CB | ZnCl₂ | 50 | Manual, | room | powder | 16,300 | 51,900 | 3.2 | 29 |
| | (2 eq) | | | | 15 min | temperature; | | | | | |
| | | | | | | overnight | | | | | |
| 33* | CMEE | CB | ZnCl₂ | 50 | Manual, | room | powder | 23,500 | 77,800 | 3.3 | 50 |
| | (2 eq) | | | | 15 min | temperature; | | | | | |
| | | | | | | overnight | | | | | |
| 34* | CMEE | CB | ZnCl₂ | 50 | Manual, | 60° C., | powder | 23,700 | 79,100 | 3.3 | 50 |
| | (2 eq) | | | | 15 min | 3 hours | | | | | |

*Denotes a comparative example

The effect of reaction temperature was studied. For the following example, the same synthetic process described in Table 1 was used except that the reaction temperature was increased to 70° C. (with addition conducted by the peristaltic pump). The results are shown in Table 5. As indicated in Table 5, the product was only partially soluble in chloroform. The molecular weight and DS % in Table 5 refer to the molecular weight and DS % of the soluble portion.

TABLE 5

| | | | Catalyst | | | | | | | | |
|---|---|---|---|---|---|---|---|---|---|---|---|
| | | Solvent | (5 wt %, | | | | | | | | |
| | Reactant | (85 wt % | based on | T | | Drying | Product | | | | |
| Ex. | (mol eq) | soln) | PPE) | (° C.) | Addition | conditions | Form | Mn | Mw | PDI | DS % |
| 35* | CMEE | CB | ZnCl₂ | 70 | pump | room | powder, | 26,600 | 132,800 | 5 | 64.5 |
| | (2 eq) | | | | (15 min) | temperature; | partially | | | | |
| | | | | | | overnight | soluble | | | | |

*Denotes a comparative example

The effect of CMEE addition rate was also studied. Varying rates of addition were tested, and the results are summarized in Table 6. Where the product was only partially soluble, the reported molecular weight and DS % are based only on the soluble fraction.

TABLE 6

| | | | Catalyst | | | | | | | | |
|---|---|---|---|---|---|---|---|---|---|---|---|
| | | Solvent | (5 wt %, | | | | | | | | |
| | Reactant | (85 wt % | based on | T | | Drying | Product | | | | |
| Ex. | (mol eq) | soln) | PPE) | (° C.) | Addition | conditions | Form | Mn | Mw | PDI | DS % |
| 36* | CMEE | CB | ZnCl₂ | 50 | pump | room | powder, | 15,000 | 55,100 | 3.7 | 38 |
| | (2 eq) | | | | (45 min) | temperature; | partially | | | | |
| | | | | | | overnight | soluble | | | | |
| 37* | CMEE | CB | ZnCl₂ | 50 | pump | room | powder | 22,700 | 76,300 | 3.4 | 41 |
| | (2 eq) | | | | (30 min) | temperature; | | | | | |
| | | | | | | overnight | | | | | |
| 38* | CMEE | CB | ZnCl₂ | 50 | pump | room | powder | 22,000 | 75,600 | 3.4 | 41 |
| | (1.5 eq) | | | | (30 min) | temperature; | | | | | |
| | | | | | | overnight | | | | | |
| 39* | CMEE | CB | ZnCl₂ | 50 | pump | 60° C., | powder | 31,200 | 173,100 | 5.6 | 32 |
| | (1 eq) | | | | (30 min) | 3 hours | | | | | |

*Denotes a comparative example

By comparing results provided in Table 6 with results shown in Table 2 it can be seen that faster addition rates can be preferred in order to avoid formation of insoluble products.

The effect of catalyst residence time was studied. In the following example, the ZnCl₂ catalyst was added into the reaction mixture 1 hour prior to addition of the CMEE reactant. As shown in Table 7, this led to formation of product with poor solubility. The reported molecular weight and DS % are based only on the soluble fraction.

TABLE 7

| | | | Catalyst | | | | | | | | |
|---|---|---|---|---|---|---|---|---|---|---|---|
| | | Solvent | (5 wt %, | | | | | | | | |
| | Reactant | (85 wt % | based on | T | | Drying | Product | | | | |
| Ex. | (mol eq) | soln) | PPE) | (° C.) | Addition | conditions | Form | Mn | Mw | PDI | DS % |
| 40* | CMEE | CB | ZnCl₂ | 50 | pump | room | powder, | 28,100 | 151,200 | 5.4 | 41 |
| | (2 eq) | | | | (15 min) | temperature; | partially | | | | |
| | | | | | | overnight | soluble | | | | |

*Denotes a comparative example

As a further comparative example, a chloromethylated polyphenylene ether was made according to a procedure adapted from Int. J. of Hydrogen Energy, 39 (2014), 2659-2668. Briefly, 2 grams of polyphenylene ether was dissolved in chlorobenzene (15 wt % solution) at 30° C. Zinc chloride as catalyst (5 weight percent based on polymer weight) was added to reaction mixture, yielding a heterogenous reaction mixture due to insolubility of catalyst in the chlorobenzene. Chloromethyl ethyl ether (CMEE) and added dropwise to the polyphenylene ether mixture. The mixture was stirred for 5 hours at 50° C., and then cooled. After cooling, the product was precipitated with methanol (34 mL), filtered, and washed with distilled water twice (34 mL each time) and dried in an oven for 24 hours at 70° C.

Results are shown in Table 8. As shown in Table 8, the comparative process afforded a chloromethylated polyphenylene ether having high residual amounts of dimethoxy methane and chlorobenzene relative to a chloromethylated polyphenylene ether according to the present disclosure. Furthermore, the comparative process afforded a chloromethylated polyphenylene ether having high residual zinc levels (average 4000 ppm). The high zinc content as well as the range observed was due to the heterogeneity of the resulting sample.

TABLE 8

| | Example 41* |
|---|---|
| Total DS % | 44.9 |
| Major DS % | 44.9 |
| Zn (avg., ppm) | 4000 |
| Moisture (wt %) | 0.2 |
| DMM (ppm) | 0.82% |
| DEM (ppm) | <10 |
| MeOH (ppm) | 127 |
| EtOH (ppm) | <10 |
| ClBz (ppm) | 11.2% |
| Mn (Da) | 21963 |
| Mw (Da) | 58719 |
| PDI | 2.7 |
| <1 kDa | 0.26 |
| (wt %) | |
| <500 Da | 0.13 |
| (wt %) | |

*Denotes a comparative example

This disclosure further encompasses the following aspects.

Aspect 1: A halomethylated polyphenylene ether comprising 35 to 89 mole percent of a first repeating unit of formula (I)

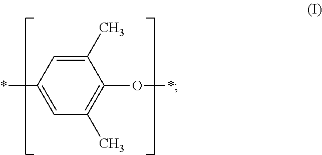

10 to 65 mole percent of a second repeating unit of formula (II)

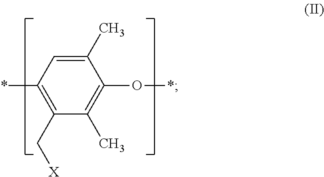

and
1 mole percent or less of a third repeating unit of formula (III)

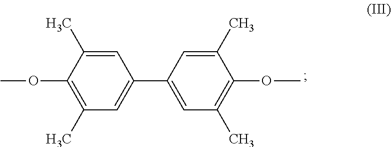

wherein X in Formula (II) is bromine or chlorine; wherein at least 90% of halomethylated repeat units are monohalomethylated repeating units of Formula (II), as determined by nuclear magnetic resonance spectroscopy; and wherein the halomethylated polyphenylene ether has a residual zinc content of less than 1000 ppm, based on the total weight of the halomethylated polyphenylene ether.

Aspect 2: The halomethylated polyphenylene ether of aspect 1, further comprising: 1 mole percent or less of a fourth repeating unit of formula (IV)

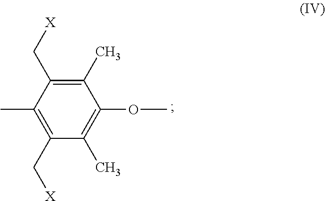

1 mole nercent or less of a fifth reneating unit of formula (V)

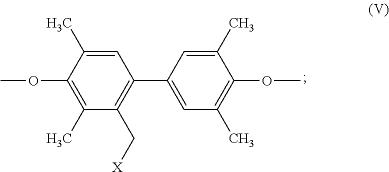

1 mole percent or less of a sixth repeating unit of formula (VI)

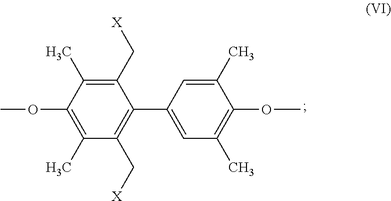

1 mole percent or less of a seventh repeating unit of formula (VII)

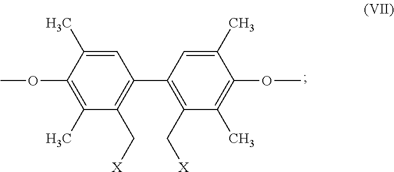

1 mole percent or less of an eight repeating unit of formula (VIII)

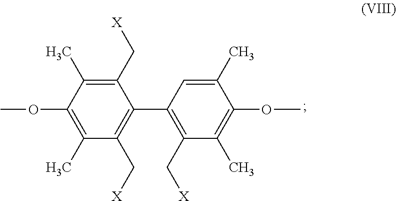

and
1 mole percent or less of a ninth repeating unit of formula (IX)

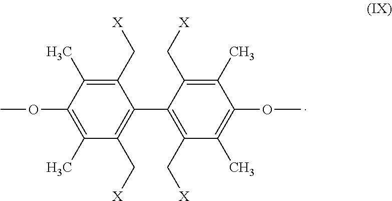

Aspect 3: The halomethylated polypbenylene ether of aspect 1 or 2, wherein the halomethylated polyphenylene ether has a weight average molecular weight of least 40,000 grams per mole, preferably 40,000 to 150,000 grams per mole, as determined by gel permeation chromatography eluting with chloroform and relative to polystyrene standards.

Aspect 4: The halomethylated polyphenylene ether of any of aspects 1 to 3, wherein the halomethylated polyphenylene ether has a residual zine content of less than 500 ppm, or less than 100 ppm, or less than 50 ppm, or less than 20 ppm, each based on the total weight of the halomethylated polyphenylene ether; a dialkoxyalkane content of less than 20 ppm, or less than 10 ppm, each based on the total weight of the halomethylated polyphenylene ether, preferably wherein the halomethylated polyphenylene ether has a combined diethoxymethane and dimethoxymethane content of less than 20 ppm, or less than 10 ppm, each based on the total weight of the halomethylated polyphenylene ether; an oligomer content of less than 1 weight percent, based on the total weight of the halomethylated polyphenylene ether, wherein the oligomer is a phenylene ether oligomer having a weight average molecular weight of less than 1000 grams per mole; or a combination thereof.

Aspect 5: The halomethylated polyphenylene ether of any of aspects 1 to 4, wherein the halomethylated polyphenylene ether is made by a method comprising: contacting a polyphenylene ether with chloromethyl ethyl ether to provide the chloromethylated polyphenylene ether; or contacting a polyphenylene ether with bromomethyl methyl ether to provide the bromomethylated polyphenylene ether.

Aspect 6: The halomethylated polyphenylene ether of aspect 5, wherein the contacting is using a polyphenylene ether:chloromethyl ethyl ether molar ratio or a polyphenylene ether:bromomethyl methyl ether molar ratio of 1.9:1 to 2.1:1, preferably 2:1; wherein the contacting to provide the halomethylated polyphenylene ether is at a temperature of 25 to 75° C., preferably 30 to 75° C., or greater than 30 to less than 70° C., or greater than 30 to 65° C., or 40 to 60° C., or 45 to 55° C. and a time of 1 to 10 hours; wherein the contacting is in the presence of a solvent, preferably chlorobenzene or ortho-dichlorobenzene; wherein the contacting is in the presence of a catalyst, preferably a Lewis acid catalyst, more preferably a zinc-containing Lewis acid catalyst; and the catalyst is present in an amount of 3 to 7 weight percent, based on the weight of the polyphenylene ether.

Aspect 7: A method for the manufacture of a halomethylated polyphenylene ether, the method comprising: contacting a polyphenylene ether with chloromethyl ethyl ether to provide a mixture comprising a chloromethylated polyphenylene ether or contacting a polyphenylene ether with bromomethyl methyl ether to provide a bromomethylated polyphenylene ether; and isolating the halomethylated polyphenylene ether from the mixture; wherein isolating the halomethylated polyphenylene ether comprises: precipitating the halomethylated polyphenylene ether from the mixture in an antisolvent, preferably methanol or methanolic hydrochloric acid; filtering the precipitated halomethylated polyphenylene ether; washing the halomethylated polyphenylene ether, preferably with water, aqueous hydrochloric acid, or a combination thereof; and dissolving the filtered halomethylated polyphenylene ether in a solvent to provide a purified halomethylated polyphenylene ether solution, and adding a chelating agent, an ion exchange resin, carbonaceous material, or a combination thereof to the purified halomethylated polyphenylene ether solution.

Aspect 8: The method of aspect 7, wherein the polyphenylene ether comprises a poly(2,6-dimethyl-1,4-phenylene ether).

Aspect 9: The method of aspect 7 or 8, wherein the contacting is using a polyphenylene ether:chloromethyl ethyl ether molar ratio or a polyphenylene ether:bromomethyl methyl ether molar ratio of 1.9:1 to 2.1:1, preferably 2:1; the contacting is at a temperature of 25 to 75° C., preferably 30 to 75° C., or greater than 30 to less than 70° C., or greater than 30 to 65° C., or 40 to 60° C., or 45 to 55° C. and a time of 1 to 10 hours; the contacting is in the presence of a catalyst, preferably a Lewis acid catalyst, more preferably a zinc-containing Lewis acid catalyst; and the catalyst is present in an amount of 3 to 7 weight percent, based on the weight of the polyphenylene ether.

Aspect 10: The method of aspect 9, wherein the catalyst is dissolved in a solvent prior to the contacting to provide a homogenous mixture.

Aspect 11: The method of any of aspects 7 to 10, wherein the halomethylated polyphenylene ether has a degree of halomethylation of 5 to 100%, as determined by nuclear magnetic resonance spectroscopy, and wherein at least 90% of the halomethylated repeat units are monohalomethylated.

Aspect 12: The method of any of aspects 7 to 11, wherein the halomethylated polyphenylene ether comprises 35 to 89 mole percent of a first repeating unit of formula (I)

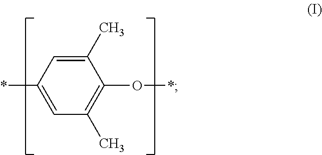

10 to 65 mole percent of a second repeating unit of formula (II)

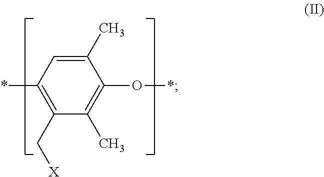

and
1 mole percent or less of a third repeating unit of formula (III)

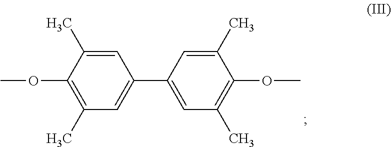

wherein X in Formula (II) is bromine or chlorine; and wherein the halomethylated polyphenylene ether has a residual zinc content of less than 1000 ppm, based on the total weight of the halomethylated polyphenylene ether.

Aspect 13: A quaternary-amine containing polyphenylene ether derived from the halomethylated polyphenylene ether of any of aspect 1 to 6.

Aspect 14: An article comprising the halomethylated polyphenylene ether of any of aspects 1 to 6, the halomethylated polyphenylene ether made by the method of any of aspects 7 to 12, or the quaternary amine-containing polyphenylene ether of aspect 13, preferably wherein the article is membrane, more preferably an ion separator membrane.

Aspect 15: An anion exchange membrane comprising the quaternary amine-containing polyphenylene ether of aspect 13.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “an aspect” means that a particular element described in connection with the aspect is included in at least one aspect described herein, and may or may not be present in other aspects. The term “combination thereof” as used herein includes one or more of the listed elements, and is open, allowing the presence of one or more like elements not named. In addition, it is to be understood that the described elements may be combined in any suitable manner in the various aspects.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

As used herein, the term “hydrocarbyl”, whether used by itself, or as a prefix, suffix, or fragment of another term, refers to a residue that contains only carbon and hydrogen. The residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. However, when the hydrocarbyl residue is described as substituted, it may, optionally, contain heteroatoms over and above the carbon and hydrogen members of the substituent residue. Thus, when specifically described as substituted, the hydrocarbyl residue can also contain one or more carbonyl groups, amino groups, hydroxyl groups, or the like, or it can contain heteroatoms within the backbone of the hydrocarbyl residue. The term “alkyl” means a branched or straight chain, saturated aliphatic hydrocarbon group, e.g., methyl, ethyl, n-propyl, i-propyl, n-butyl, s-butyl, t-butyl, n-pentyl, s-pentyl, and n- and s-hexyl. “Alkenyl” means a straight or branched chain, monovalent hydrocarbon group having at least one carbon-carbon double bond (e.g., ethenyl (—HC═CH₂)). “Alkoxy” means an alkyl group that is linked via an oxygen (i.e., alkyl-O—), for example methoxy, ethoxy, and sec-butyloxy groups. “Alkylene” means a straight or branched chain, saturated, divalent aliphatic hydrocarbon group (e.g., methylene (—CH₂—) or, propylene (—(CH₂)₃—)). “Cycloalkylene” means a divalent cyclic alkylene group, —CₙH₂ₙ₋ₓ, wherein x is the number of hydrogens replaced by cyclization(s). “Cycloalkenyl” means a monovalent group having one or more rings and one or more carbon-carbon double bonds in the ring, wherein all ring members are carbon (e.g., cyclopentyl and cyclohexyl). “Aryl” means an aromatic hydrocarbon group containing the specified number of carbon atoms, such as phenyl, tropone, indanyl, or naphthyl. “Arylene” means a divalent aryl group. “Alkylarylene” means an arylene group substituted with an alkyl group. “Arylalkylene” means an alkylene group substituted with an aryl group (e.g., benzyl). The prefix “halo” means a group or compound including one more of a fluoro, chloro, bromo, or iodo substituent. A combination of different halo atoms (e.g., bromo and fluoro), or only chloro atoms can be present. The prefix “hetero” means that the compound or group includes at least one ring member that is a heteroatom (e.g., 1, 2, or 3 heteroatom(s)), wherein the heteroatom(s) is each independently N, O, S, Si, or P. “Substituted” means that the compound or group is substituted with at least one (e.g., 1, 2, 3, or 4) substituents that can each independently be a C₁₋₉ alkoxy, a C₁₋₉ haloalkoxy, a nitro (—NO₂), a cyano (—CN), a C₁₋₆ alkyl sulfonyl (—S(═O)₂-alkyl), a C₆₋₁₂ aryl sulfonyl (—S(═O)₂-aryl), a thiol (—SH), a thiocyano (—SCN), a tosyl (CH₃C₆H₄SO₂—), a C₃₋₁₂ cycloalkyl, a C₂₋₁₂ alkenyl, a C₅₋₁₂ cycloalkenyl, a C₆₋₁₂ aryl, a C₇₋₁₃ arylalkylene, a C₄₋₁₂ heterocycloalkyl, and a C₃₋₁₂ heteroaryl instead of hydrogen, provided that the substituted atom's normal valence is not exceeded. The number of carbon atoms indicated in a group is exclusive of any substituents. For example —CH₂CH₂CN is a C₂ alkyl group substituted with a nitrile.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A halomethylated polyphenylene ether comprising
35 to 89 mole percent of a first repeating unit of formula (I) 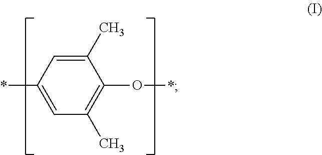
10 to 65 mole percent of a second repeating unit of formula (II) 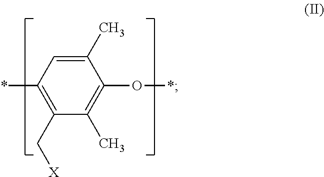
and
1 mole percent or less of a third repeating unit of formula (III) 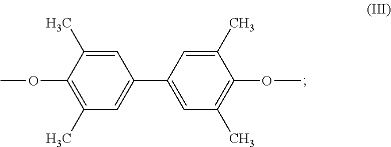
wherein X in Formula (II) is bromine or chlorine;
wherein at least 90% of halomethylated repeat units are monohalomethylated repeating units of Formula (II), as determined by nuclear magnetic resonance spectroscopy; and
wherein the halomethylated polyphenylene ether has a residual zinc content of less than 1000 ppm, based on the total weight of the halomethylated polyphenylene ether.

2. The halomethylated polyphenylene ether of claim 1, further comprising:
1 mole percent or less of a fourth repeating unit of formula (IV) 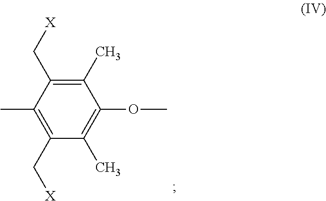
1 mole percent or less of a fifth repeating unit of formula (V) 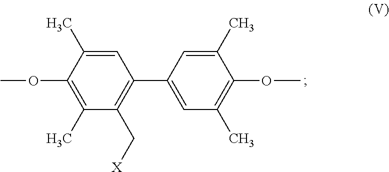
1 mole percent or less of a sixth repeating unit of formula (VI) 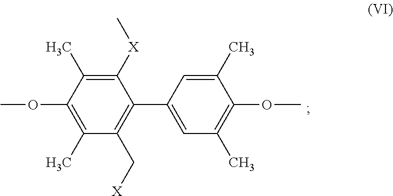
1 mole percent or less of a seventh repeating unit of formula (VII) 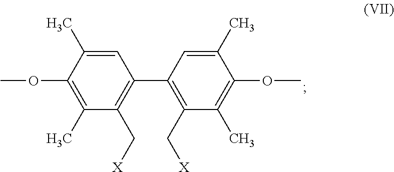
1 mole percent or less of an eight repeating unit of formula (VIII) 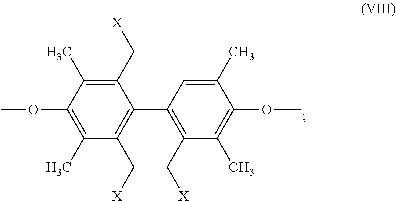
and
1 mole percent or less of a ninth repeating unit of formula (IX)

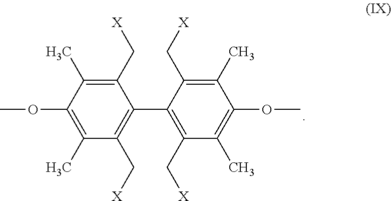

3. The halomethylated polyphenylene ether of claim 1, wherein the halomethylated polyphenylene ether has a weight average molecular weight of least 40,000 grams per mole as determined by gel permeation chromatography eluting with chloroform and relative to polystyrene standards.

4. The halomethylated polyphenylene ether of claim 1, wherein the halomethylated polyphenylene ether has
a residual zinc content of less than 500 ppm based on the total weight of the halomethylated polyphenylene ether;
a dialkoxyalkane content of less than 20 ppm based on the total weight of the halomethylated polyphenylene ether;
an oligomer content of less than 1 weight percent, based on the total weight of the halomethylated polyphenylene ether, wherein the oligomer is a phenylene ether oligomer having a weight average molecular weight of less than 1000 grams per mole;
or a combination thereof.

5. The halomethylated polyphenylene ether of claim 1, wherein the halomethylated polyphenylene ether is made by a method comprising:
contacting a polyphenylene ether with chloromethyl ethyl ether to provide the chloromethylated polyphenylene ether; or
contacting a polyphenylene ether with bromomethyl methyl ether to provide the bromomethylated polyphenylene ether.

6. The halomethylated polyphenylene ether of claim 5,
wherein the contacting is using a polyphenylene ether:chloromethyl ethyl ether molar ratio or a polyphenylene ether:bromomethyl methyl ether molar ratio of 1.9:1 to 2.1:1;
wherein the contacting to provide the halomethylated polyphenylene ether is at a temperature of 25 to 75° C. and a time of 1 to 10 hours;
wherein the contacting is in the presence of a solvent;
wherein the contacting is in the presence of a catalyst; and
the catalyst is present in an amount of 3 to 7 weight percent, based on the weight of the polyphenylene ether.

7. A method for the manufacture of a halomethylated polyphenylene ether, the method comprising:
contacting a polyphenylene ether with chloromethyl ethyl ether to provide a mixture comprising a chloromethylated polyphenylene ether or contacting a polyphenylene ether with bromomethyl methyl ether to provide a bromomethylated polyphenylene ether; and
isolating the halomethylated polyphenylene ether from the mixture;
wherein isolating the halomethylated polyphenylene ether comprises:
precipitating the halomethylated polyphenylene ether from the mixture in an antisolvent;
filtering the precipitated halomethylated polyphenylene ether;
washing the halomethylated polyphenylene ether; and
dissolving the filtered halomethylated polyphenylene ether in a solvent to provide a purified halomethylated polyphenylene ether solution, and adding a chelating agent, an ion exchange resin, carbonaceous material, or a combination thereof to the purified halomethylated polyphenylene ether solution.

8. The method of claim 7, wherein the polyphenylene ether comprises a poly(2,6-dimethyl-1,4-phenylene ether).

9. The method of claim 7, wherein
the contacting is using a polyphenylene ether:chloromethyl ethyl ether molar ratio or a polyphenylene ether:bromomethyl methyl ether molar ratio of 1.9:1 to 2.1:1;
the contacting is at a temperature of 25 to 75° C. and a time of 1 to 10 hours;
the contacting is in the presence of a catalyst; and
the catalyst is present in an amount of 3 to 7 weight percent, based on the weight of the polyphenylene ether.

10. The method of claim 9, wherein the catalyst is dissolved in a solvent prior to the contacting to provide a homogenous mixture.

11. The method of claim 7,
wherein the halomethylated polyphenylene ether has a degree of halomethylation of 5 to 100%, as determined by nuclear magnetic resonance spectroscopy, and
wherein at least 90% of the halomethylated repeat units are monohalomethylated.

12. The method of claim 7, wherein the halomethylated polyphenylene ether comprises
35 to 89 mole percent of a first repeating unit of formula (I) 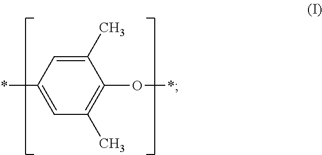
10 to 65 mole percent of a second repeating unit of formula (II) 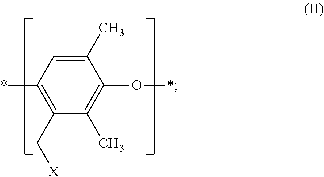
and
1 mole percent or less of a third repeating unit of formula (III) 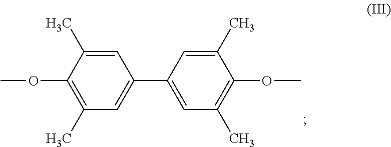
wherein X in Formula (II) is bromine or chlorine; and
wherein the halomethylated polyphenylene ether has a residual zinc content of less than 1000 ppm, based on the total weight of the halomethylated polyphenylene ether.

13. A quaternary-amine containing polyphenylene ether derived from the halomethylated polyphenylene ether of claim 1.

14. An article comprising the halomethylated polyphenylene ether of claim 1.

15. An anion exchange membrane comprising the quaternary amine-containing polyphenylene ether of claim 13.

16. The halomethylated polyphenylene ether of claim 1 wherein the halomethylated polyphenylene ether has a combined diethoxymethane and dimethoxymethane content of less than 20 ppm based on the total weight of the halomethylated polyphenylene ether.

17. The article of claim 14, wherein the article is a membrane.
